(19) United States
(12) Patent Application Publication
(10) Pub. No.: US 2010/0144298 A1
(43) Pub. Date: Jun. 10, 2010

(54) APPARATUS AND METHOD FOR GENERATING IN-PHASE SIGNAL AND QUADRATURE SIGNAL OF MULTI-PORT NETWORK

(75) Inventors: Chang Soo YANG, Seongnam (KR); Hyung Chul Park, Daejeon (KR); Sang Yub Lee, Seongnam (KR)

Correspondence Address: LOWE HAUPTMAN HAM & BERNER, LLP, 1700 DIAGONAL ROAD, SUITE 300, ALEXANDRIA, VA, 22314, US

(73) Assignees: Samsung Electro-Mechanics Co., Ltd., SUWON (KR); Hanbat National University-Academic Cooperation Foundation, Daejeon (KR)

(21) Appl. No.: 12/618,156

(22) Filed: Nov. 13, 2009

(30) Foreign Application Priority Data
Dec. 8, 2008 (KR) 10-2008-0124066

(51) Int. Cl. H04B 1/16

(52) U.S. Cl. 455/205

(57) ABSTRACT

Provided is an apparatus and method for generating I/Q signals in a multi-port network, which can generate I/Q signals with accurate coordinates and sizes by repeatedly controlling the coordinates and size of an initial parameter in accordance with a predetermined reference condition. The I/Q signal generating apparatus of a multi-port network includes a multi-port network unit, a signal generation unit, and a control unit. The multi-port network unit converts a receive (RX) signal into a plurality of phase signals with different phases in accordance with a predetermined reference signal. The signal generation unit restores original data on the basis of the power of the phase signals received from the multi-port network unit. The control unit controls the restoration operation of the signal generation unit to be repeated so that the original data restored by the signal generation unit satisfies a predetermined reference range.

### CROSS-REFERENCE TO RELATED APPLICATIONS

This application claims the priority of Korean Patent Application No. 10-2008-0124066 filed on Dec. 8, 2008, in the Korean Intellectual Property Office, the disclosure of which is incorporated herein by reference.

### BACKGROUND OF THE INVENTION

1. Field of the Invention

The present invention relates to an apparatus and method for generating in-phase/quadrature (I/Q) signals, and more particularly, to an apparatus and method for generating I/Q signals of a multi-port network, which can generate I/Q signals with accurate coordinates and sizes by repeatedly controlling the coordinates and size of an initial parameter in accordance with a predetermined reference condition.

2. Description of the Related Art

In general, a Radio Frequency (RF) receiver having a multi-port network with multiple input/output ports, such as a 5-port network or a 6-port network, is suitable for the structure of a Software Defined Radio (SDR) receiver because it is lower in power consumption than an RF receiver using an active device and has broadband characteristics.

An SDR technology is a radio access based technology that is used to integrate/accommodate a plurality of radio communication standards through a single communication system on the basis of a high-tech digital signal processing technology, a system software technology and a high-performance digital signal processing device by changing modularized software without hardware modification.

The RF receiver having a multi-port network generates I/Q signals by using single-frequency continuous wave signals received from the multi-port network. However, because the size and phase of each of the generated parameters are not accurate, it is difficult to generate I/Q signals with correct information.

### SUMMARY OF THE INVENTION

An aspect of the present invention provides an apparatus and method for generating I/Q signals of a multi-port network, which can generate I/Q signals with accurate coordinates and sizes by repeatedly controlling the coordinates and size of and initial parameter in accordance with a predetermined reference condition.

According to an aspect of the present invention, there is provided an I/Q signal generating apparatus of a multi-port network, including: a multi-port network unit converting a receive (RX) signal into a plurality of phase signals with different phases in accordance with a predetermined reference signal; a signal generation unit restoring original data on the basis of the power of the phase signals received from the multi-port network unit; and a control unit controlling the restoration operation of the signal generation unit to be repeated so that the original data restored by the signal generation unit satisfies a predetermined reference range.

The signal generation unit may include: an initial parameter calculation unit calculating an initial I/Q generation parameter by using the phase shifts of the I/Q signals generated from the power of the phase signals received from the multi-port network unit; a phase rotation unit calculating a corrected I/Q generation parameter by correcting the phase of the initial I/Q generation parameter received from the initial parameter calculation unit; and a parameter normalization unit calculating a final I/Q generation parameter by normalizing the size of the corrected I/Q generation parameter received from the phase rotation unit.

The control unit may include: a first controller controlling the phase correction operation of the phase rotation unit to be repeated so that the sign of the phase of the previous corrected I/Q generation parameter and the sign of the phase of the current corrected I/Q generation parameter among the corrected I/Q generation parameters received from the phase rotation unit are opposite to each other; and a second controller controlling the normalization operation of the parameter normalization unit to be repeated so that the I value and the Q value among the final I/Q generation parameters received from the parameter normalization unit have a predetermined level.

Under the control of the first controller, the phase rotation unit may calculate the corrected I/Q generation parameter by using the initial I/Q generation parameter received from the initial parameter calculation unit to correct the phase of the initial I/Q generation parameter so that the major axis of the I/Q signals generated in the shape of an ellipse coincides with the X axis.

The multi-port network unit may include: a multi-port network dividing the RX signal into a plurality of signals, and adds the plural signals respectively to a plurality of carrier signals with different phases in accordance with a reference signal to output the phase signals with different phases; and a power detection unit detecting the power of the phase signals received from the multi-port network.

The multi-port network may further include a filter unit 113 filtering the power detection signals received from the power detection unit to block noises other than the power detection signals.

According to another aspect of the present invention, there is provided an I/Q signal generating method for restoring original data on the basis of the power of a plurality of phase signals with difference phases received from a multi-port network, including: calculating an initial I/Q generation parameter by using the phase shift of I/Q signals generated from the power of the phase signals; correcting the phase of the initial I/Q generation parameter to calculate a corrected I/Q generation parameter, and repeating the phase correction operation so that the sign of the phase of the previous corrected I/Q generation parameter and the signal of the phase of the current corrected I/Q generation parameter, among the corrected I/Q generation parameters, are opposite to each other; and normalizing the size of the corrected I/Q generation parameter to calculate a final I/Q generation parameter, and repeating the normalization operation so that the I value and the Q value among the final I/Q generation parameters have a predetermined level.

The repeating of the phase correction operation may calculate the corrected I/Q generation parameter by using the initial I/Q generation parameter to correct the phase of the initial I/Q generation parameter so that the major axis of the I/Q signals generated in the shape of an ellipse coincides with the X axis.

The phase correction operation and the normalization operation may be repeated a predetermined number of times.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of an I/Q signal generating apparatus according to an embodiment of the present invention;

FIG. 2 is a flow diagram of an I/Q signal generating method according to an embodiment of the present invention;

FIG. 3 is a locus diagram of a receive (RX) signal inputted to a 5-port network according to an embodiment of the present invention;

FIG. 4 is a locus diagram of I/Q signals generated from a power detection signal and an uninitialized I/Q generation parameter according to an embodiment of the present invention;

FIG. 5 is a locus diagram of I/Q signals generated from an initial I/Q generation parameter calculated by an initial parameter calculation unit according to an embodiment of the present invention;

FIG. 6 is a locus diagram of I/Q signals generated from a corrected I/Q generation parameter outputted from a phase rotation unit according to an embodiment of the present invention; and

FIG. 7 is a locus diagram of I/Q signals generated from a final I/Q generation parameter outputted from a parameter normalization unit according to an embodiment of the present invention.

### DETAILED DESCRIPTION OF THE PREFERRED EMBODIMENT

Exemplary embodiments of the present invention will now be described in detail with reference to the accompanying drawings.

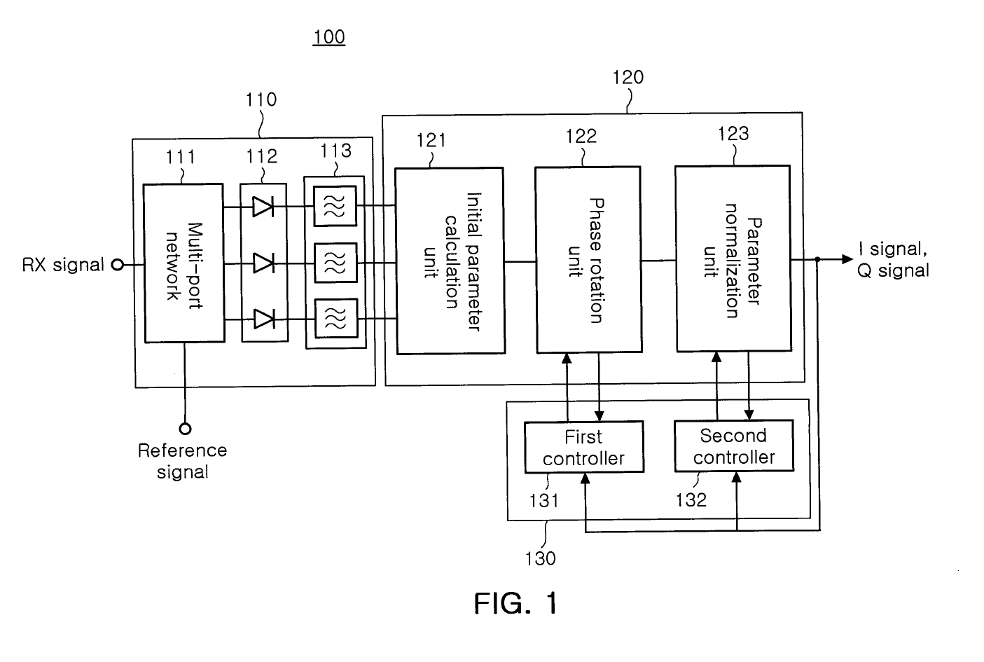

FIG. 1 is a block diagram of an I/Q signal generating apparatus according to an embodiment of the present invention. Referring to FIG. 1, an I/Q signal generating apparatus according to an embodiment of the present invention may include a multi-port network unit 110, a signal generation unit 120, and a control unit 130.

The multi-port network unit 110 may include a multi-port network 111 and a power detection unit 112. The multi-port network 111 divides a receive (RX) signal into a plurality of signals, and adds the plural signals respectively to a plurality of carrier signals with different phases in accordance with a reference signal to output a plurality of phase signals with different phases. The power detection unit 112 detects the power of the phase signals received from the multi-port network 111. The multi-port network 111 may be a 5-port network that receives the RX signal and the reference signal to output three phase signals, or a 6-port network that receives the RX signal and the reference signal to output four phase signals.

Also, the multi-port network unit 110 may further include a filter unit 113. The filter unit 113 filters a plurality of power detection signals received from the power detection unit 112 to block noises other than the power detection signals.

The signal generation unit 120 may include an initial parameter calculation unit 121, a phase rotation unit 122, and a parameter normalization unit 123. The initial parameter calculation unit 121 calculates an initial I/Q generation parameter by using the phase shifts of an I signal and a Q signal generated from the power detection signals filtered by the filter unit 113 of the multi-port network unit 110. The phase rotation unit 122 calculates a corrected I/Q generation parameter by correcting the phase of the initial I/Q generation parameter received from the initial parameter calculation unit 121. The parameter normalization unit 123 calculates a final I/Q generation parameter by normalizing the size of the corrected I/Q generation parameter received from the phase rotation unit 122.

The operation of the phase rotation unit 122 and the operation of the parameter normalization unit 123 may be controlled to be performed repeatedly.

The control unit 130 may include a first controller 131 and a second controller 132. The first controller 131 controls the phase correction operation of the phase rotation unit 122 to be repeated so that the sign of the phase of the previous corrected I/Q generation parameter and the sign of the phase of the current corrected I/Q generation parameter among the corrected I/Q generation parameters received from the phase rotation unit 122 are opposite to each other. The second controller 132 controls the normalization operation of the parameter normalization unit 123 to be repeated so that the I value and the Q value among the final I/Q generation parameters received from the parameter normalization unit 123 have a predetermined level.

Accordingly, under the control of the first controller 131, the phase rotation unit 122 may calculate the corrected I/Q generation parameter by using the initial I/Q generation parameter received from the initial parameter calculation unit 121 to correct the phase of the initial I/Q generation parameter so that the major axis of I/Q signals generated in the shape of an ellipse coincides with the X axis.

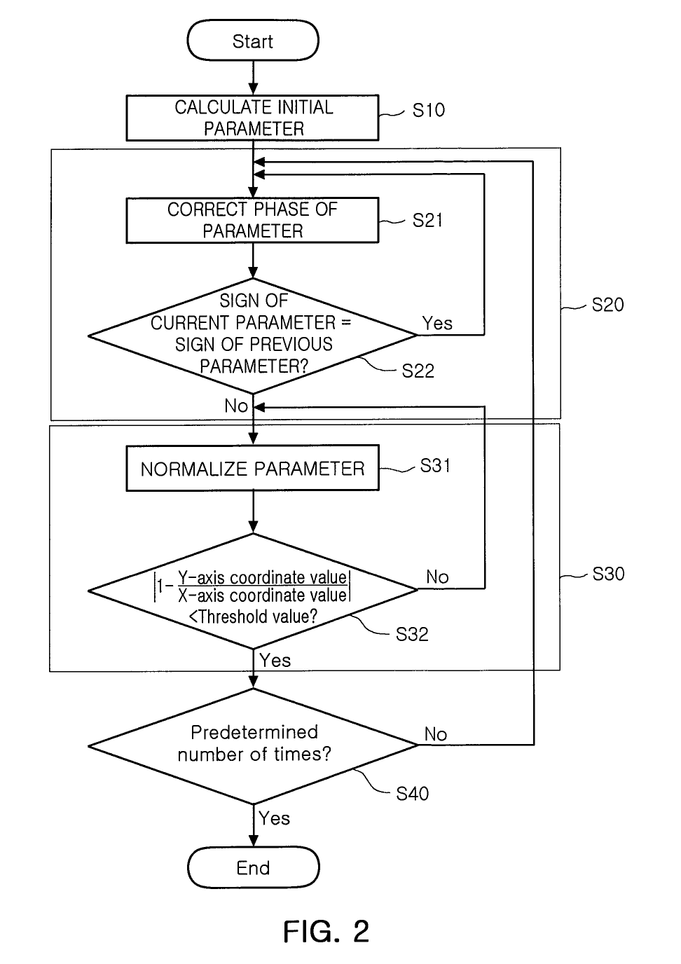

FIG. 2 is a flow diagram of an I/Q signal generating method according to an embodiment of the present invention.

Referring to FIGS. 1 and 2, in step S10, an initial parameter is calculated from the power detection signals received from the multi-port network unit 110.

That is, the multi-port network 111 uses a single-frequency continuous wave RX signal, divides the RX signal into three signal in the case of the 5-port network (four signals in the case of the 6-port network), and adds the three signals respectively to the first to third carrier signals with different phases (the first to fourth carrier signals with different phases in the case of the 6-port network) in accordance with the reference signal to output the first to third phase signals with different phases (the first to fourth phase signals with different phases in the case of the 6-port network).

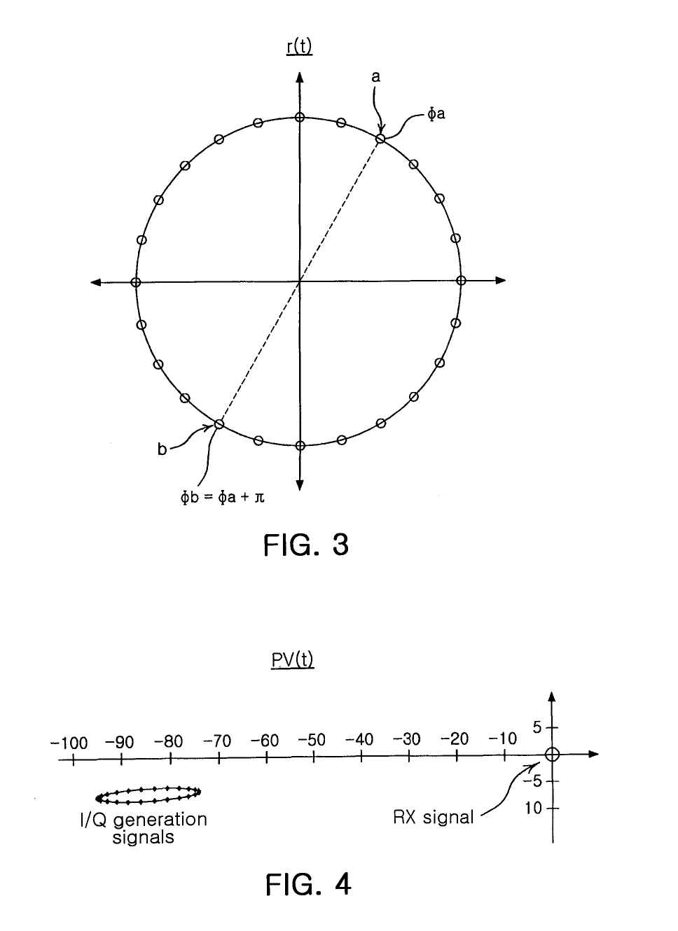

FIG. 3 is a locus diagram of the RX signal inputted to the multi-port network according to an embodiment of the present invention.

Referring to FIG. 3, in the locus of the RX signal r(t) inputted to the multi-port network 111, if a point ‘a’ is denoted by ‘Φa’ , a point ‘b’ having a 180° phase difference with respect to the point ‘ a’ can be denoted by ‘Φ+π=Φb’. Accordingly, from the RX signal r(t) illustrated in FIG. 3, the signal generation unit 120 can detect one point and another point having a 180° phase difference with respect to the point.

The initial parameter calculation unit 121 detects two factors Φ and Φ+π in accordance with the phase shift of the I/Q signals generated from the power detection signals received from the power detection unit 112, and calculates an initial I/Q generation parameter IPV so that a DC offset is removed from the two factors Φ and Φ+π.

Accordingly, the initial parameter calculation unit 121 calculates the initial I/Q generation parameter IPV by using the phase shift of the I/Q signals generated from the first to third power detection signals received from the power detection unit 112.

That is, the initial parameter calculation unit 121 detects two factors Φa and Φa+π in accordance with the phase shift of the I/Q signals generated from the first, second and third power detection signals received from the power detection unit 112, and calculates an initial I/Q generation parameter IPV so that a DC offset is removed from the two factors Φa and Φa+π.

That is, the I/Q signals generated by the signal generation unit 120 are regenerated from the first, second and third power detection signals received from the power detection unit 112, in accordance with Equation (1).

Iᵣ(t)=A_{I1}P₁(t)+A_{I2}P₂(t)+A_{I3}P₃(t)

Qᵣ(t)=A_{Q1}P₁(t)+A_{Q2}P₂(t)+A_{Q3}P₃(t) (1)

In Equation (1), A_{I1}, A_{I2}, A_{I3}, A_{Q1}, A_{Q2} and A_{Q3} denote the I/Q generation parameters, and P₁, P₂ and P₃ denote the first, second and third power detection signals received from the power detection unit 112.

Meanwhile, it can be seen from FIG. 3 that, for the single-frequency continuous wave RX signal, a signal with a phase of Φa and a signal with a phase of Φa+π are a real signal component and an imaginary signal component that are identical in size but are opposite in polarity.

Thus, when the first, second and third power detection signals with a phase difference of p received from the power detection unit 112 are inputted to Equation 1, a rearranged equation for an I generation signal and a Q generation signal can be expressed as Equation (2).

Iᵣ(t)C_{Φ(t)=Φa}=A_{I1}P₁(t)C_{Φ(t)=Φa}+A_{I2}P₂(t)C_{Φ(t)=Φa}+A_{I3}P₃(t)C_{Φ(t)=Φa}

Iᵣ(t)C_{Φ(t)=Φa+π}=A_{I1}P₁(t)C_{Φ(t)=Φa+π}+A_{I2}P₂(t)C_{Φ(t)=Φa+π}+A_{I3}P₃(t)C_{Φ(t)=Φa+π}

Qᵣ(t)C_{Φ(t)=Φa}=A_{Q1}P₁(t)C_{Φ(t)=Φa}+A_{Q2}P₂(t)C_{Φ(t)=Φa}+A_{Q3}P₃(t)C_{Φ(t)=Φa}

Qᵣ(t)C_{Φ(t)=Φa+π}=A_{Q1}P₁(t)C_{Φ(t)=Φa+π}+A_{Q2}P₂(t)C_{Φ(t)=Φa+π}+A_{Q3}P₃(t)C_{Φ(t)=Φa+π} (2)

In Equation (2), the DC offset can be removed if the initial I/Q generation parameter is determined so that the sum of I values is ‘0’ and the sum of Q values is ‘0’. The determination of the initial I/Q generation parameter can represent one of the parameters A_{I1}, A_{I2} and A_{I3} by the other parameters, and can represent one of the parameters A_{Q1}, A_{Q2} and A_{Q3} by the other parameters. For example, a rearranged equation for the parameters A_{I3} and A_{Q3} can be expressed as Equation (3).

$${A}_{13} = \frac{\begin{matrix}{A}_{11} ( {P}_{1} ( t ) {C}_{Φ ( t ) = Φ a} + {P}_{1} ( t ) {C}_{Φ ( t ) = Φ a + π} ) + \\ {A}_{12} ( {P}_{2} ( t ) {C}_{Φ ( t ) = Φ a} + {P}_{2} ( t ) {C}_{Φ ( t ) = Φ a + π} )\end{matrix}}{{P}_{3} ( t ) {C}_{Φ ( t ) = Φ a} + {P}_{3} ( t ) {C}_{Φ ( t ) = Φ a + π}} \\ {A}_{Q 3} = \frac{\begin{matrix}{A}_{Q 1} ( {P}_{1} ( t ) {C}_{Φ ( t ) = Φ a} + {P}_{1} ( t ) {C}_{Φ ( t ) = Φ a + π} ) + \\ {A}_{Q2} ( {P}_{2} ( t ) {C}_{Φ ( t ) = Φ a} + {P}_{2} ( t ) {C}_{Φ ( t ) = Φ a + π} )\end{matrix}}{{P}_{3} ( t ) {C}_{Φ ( t ) = Φ a} + {P}_{3} ( t ) {C}_{Φ ( t ) = Φ a + π}} \qquad ( 3 )$$

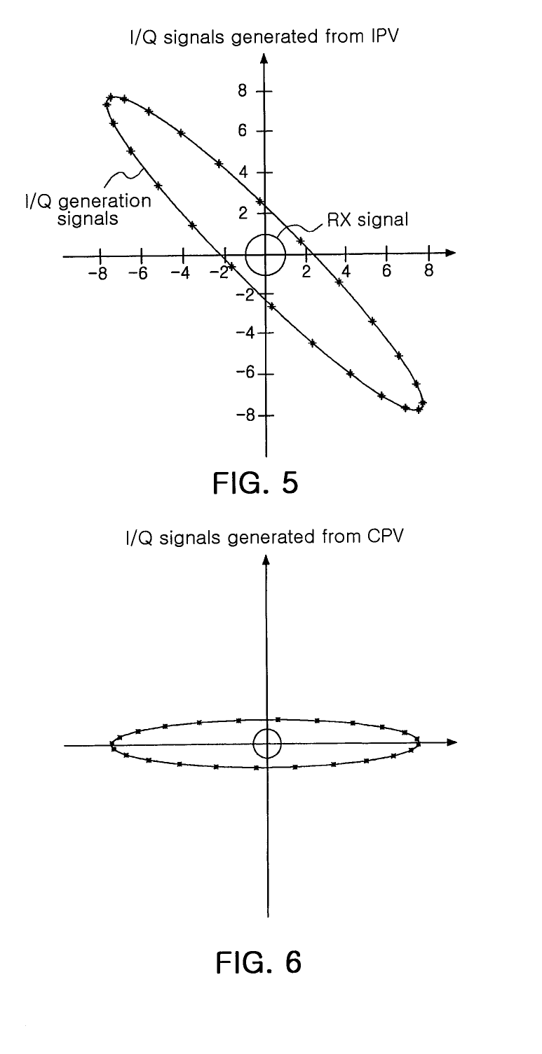

It can be seen from FIG. 5 that the DC offset is removed as a result of the calculation of the initial I/Q generation parameter.

FIG. 4 is a locus diagram of the I/Q signals generated from the power detection signal and the uninitialized I/Q generation parameter according to an embodiment of the present invention. FIG. 5 is a locus diagram of the I/Q signals generated from the initial I/Q generation parameter calculated by the initial parameter calculation unit according to an embodiment of the present invention.

The I/Q generation signals illustrated in FIG. 4 are the I/Q generation signals generated from the uninitialized I/Q generation parameter and the power detection signal inputted to the signal generation unit 120. When compared to the RX signal, the I/Q generation signals form not the shape of a circle illustrated in FIG. 3 but the shape of an ellipse illustrated in FIG. 4, so that it is distorted and has a DC offset. The DC offset and the distortion can be removed by the signal generation unit 120.

FIG. 5 is a locus diagram of the I/Q signals generated from the initial I/Q generation parameter calculated by the initial parameter calculation unit according to an embodiment of the present invention. It can be seen from FIG. 5 that the DC offset is removed from the I/Q signals generated by the initial I/Q generation parameters outputted from the initial parameter calculation unit but the locus diagram of FIG. 5 is distorted into an elliptic shape unlike the locus diagram of FIG. 4.

Thus, in step S21, the phase rotation unit 122 calculates the corrected I/Q generation parameter CPV by using the initial I/Q generation parameter IPV received from the initial parameter calculation unit 121 to correct the initial I/Q generation parameter IPV so that the major axis of the I/Q signals generated in the shape of an ellipse coincides with the X axis.

In step S22, the first controller 131 compares the previous correction value and the current correction value with respect to the phase between the X axis and the major axis of the I/Q signals continuously measured during the phase correction operation of the phase rotation unit 122, and controls the phase correction operation of the phase rotation unit 122 to be repeated until the signs of the correction values become different from each other. That is, as a result of the comparison, if the sign of the previous correction value and the sign of the current correction value become different from each other, the first controller 131 detects the approach of the major axis of the I/Q signals to the X axis and controls the phase correction operation of the phase rotation unit 122 to be repeated until the signs of the correction values become different from each other.

FIG. 6 is a locus diagram of the I/Q signals generated from the corrected I/Q generation parameter outputted from the phase rotation unit according to an embodiment of the present invention. It can be seen from FIG. 6 that the locus of the elliptic shape of the I/Q signal generated by the corrected I/Q generation parameters outputted from the phase rotation unit does not change but the major axis coincides with the X axis.

In step S31, the parameter normalization unit 123 scales the generation parameter for the I value or Q value generation signal among the corrected I/Q generation parameters CPV received from the phase rotation unit 122, to performs a normalization operation so that the maximum value of the I value and the maximum value of the Q value become equal to each other.

In step S32, the second controller 132 compares the Y-axis value and the X-axis value of the final corrected I/Q generation parameter during the normalization operation of the parameter normalization unit 123, and controls the normalization operation of the parameter normalization unit 123 to be repeated until the comparison result value becomes equal to or smaller than a predetermined threshold value. That is, the second controller 132 controls the parameter normalization unit 123 to repeat the normalization operation until the comparison result value of the Y-axis value and the X-axis value of the final corrected I/Q generation parameter becomes equal to or smaller than the predetermined threshold value.

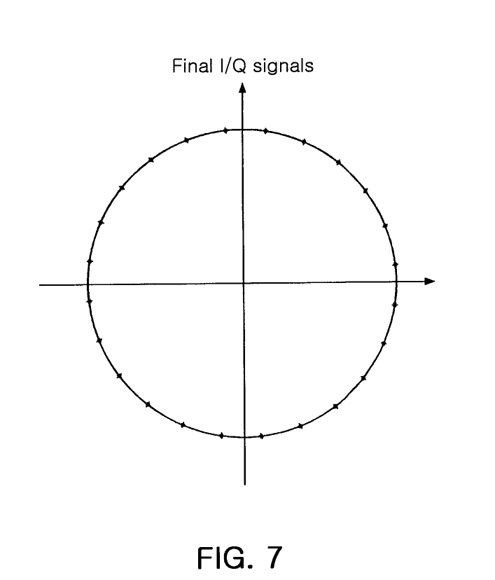

FIG. 7 is a locus diagram of the I/Q signals generated from the final I/Q generation parameter outputted from the parameter normalization unit according to an embodiment of the present invention. It can be seen from FIG. 7 that the final corrected I/Q generation parameters outputted from the parameter normalization unit exhibit a circular locus with the same size.

Lastly, in step S40, the operation of the phase rotation unit 122 and the operation of the parameter normalization unit 123 are repeated a predetermined number of times to generate more accurate I/Q signals.

The I/Q signal generating apparatus and method according to the present invention can generate the I/Q signals with accurate coordinates and sizes by repeatedly controlling the coordinates and size of the initial parameter in accordance with the predetermined reference condition.

As described above, the present invention can generate the I/Q signals with accurate coordinates and sizes by repeatedly controlling the coordinates and size of the initial parameter in accordance with the predetermined reference condition.

While the present invention has been shown and described in connection with the exemplary embodiments, it will be apparent to those skilled in the art that modifications and variations can be made without departing from the spirit and scope of the invention as defined by the appended claims.

What is claimed is:

1. An I/Q signal generating apparatus of a multi-port network, comprising:
a multi-port network unit converting a receive (RX) signal into a plurality of phase signals with different phases in accordance with a predetermined reference signal;
a signal generation unit restoring original data on the basis of the power of the phase signals received from the multi-port network unit; and
a control unit controlling the restoration operation of the signal generation unit to be repeated so that the original data restored by the signal generation unit satisfies a predetermined reference range.

2. The I/Q signal generating apparatus of claim 1, wherein the signal generation unit comprises:
an initial parameter calculation unit calculating an initial I/Q generation parameter by using the phase shifts of the I/Q signals generated from the power of the phase signals received from the multi-port network unit;
a phase rotation unit calculating a corrected I/Q generation parameter by correcting the phase of the initial I/Q generation parameter received from the initial parameter calculation unit; and
a parameter normalization unit calculating a final I/Q generation parameter by normalizing the size of the corrected I/Q generation parameter received from the phase rotation unit.

3. The I/Q signal generating apparatus of claim 2, wherein the control unit comprises:
a first controller controlling the phase correction operation of the phase rotation unit to be repeated so that the sign of the phase of the previous corrected I/Q generation parameter and the sign of the phase of the current corrected I/Q generation parameter among the corrected I/Q generation parameters received from the phase rotation unit are opposite to each other; and
a second controller controlling the normalization operation of the parameter normalization unit to be repeated so that the I value and the Q value among the final I/Q generation parameters received from the parameter normalization unit have a predetermined level.

4. The I/Q signal generating apparatus of claim 3, wherein under the control of the first controller, the phase rotation unit calculate the corrected I/Q generation parameter by using the initial I/Q generation parameter received from the initial parameter calculation unit to correct the phase of the initial I/Q generation parameter so that the major axis of the I/Q signals generated in the shape of an ellipse coincides with the X axis.

5. The I/Q signal generating apparatus of claim 1, wherein the multi-port network unit comprises:
a multi-port network dividing the RX signal into a plurality of signals, and adds the plural signals respectively to a plurality of carrier signals with different phases in accordance with a reference signal to output the phase signals with different phases; and
a power detection unit detecting the power of the phase signals received from the multi-port network.

6. The I/Q signal generating apparatus of claim 5, wherein the multi-port network further comprises:
a filter unit 113 filtering the power detection signals received from the power detection unit to block noises other than the power detection signals.

7. An I/Q signal generating method for restoring original data on the basis of the power of a plurality of phase signals with difference phases received from a multi-port network, comprising:
calculating an initial I/Q generation parameter by using the phase shift of I/Q signals generated from the power of the phase signals;
correcting the phase of the initial I/Q generation parameter to calculate a corrected I/Q generation parameter, and repeating the phase correction operation so that the sign of the phase of the previous corrected I/Q generation parameter and the signal of the phase of the current corrected I/Q generation parameter, among the corrected I/Q generation parameters, are opposite to each other; and
normalizing the size of the corrected I/Q generation parameter to calculate a final I/Q generation parameter, and repeating the normalization operation so that the I value and the Q value among the final I/Q generation parameters have a predetermined level.

8. The I/Q signal generating method of claim 7, wherein the repeating of the phase correction operation calculates the corrected I/Q generation parameter by using the initial I/Q generation parameter to correct the phase of the initial I/Q generation parameter so that the major axis of the I/Q signals generated in the shape of an ellipse coincides with the X axis.

9. The I/Q signal generating method of claim 8, wherein the phase correction operation and the normalization operation are repeated a predetermined number of times.
